(19) United States
(12) Patent Application Publication
(10) Pub. No.: US 2010/0100452 A1
(43) Pub. Date: Apr. 22, 2010

(54) VIRTUAL BUSINESS OBJECT TO MANAGE VIRTUAL WORLD TRANSACTIONS

(75) Inventors: Andrew Bryan Smith, Morrisville, NC (US); Brian Ronald Bokor, Raleigh, NC (US); Peter Frederick Haggar, Raleigh, NC (US); Daniel Edward House, Raleigh, NC (US); William Bruce Nicol, II, Durham, NC (US)

Correspondence Address: MOORE & VAN ALLEN, PLLC For IBM, P.O. Box 13706, Research Triangle Park, NC, 27709, US

(73) Assignee: INTERNATIONAL BUSINESS MACHINES CORPORATION, Armonk, NY (US)

(21) Appl. No.: 12/255,859

(22) Filed: Oct. 22, 2008

(51) Int. Cl. G06Q 30/00; H04L 9/32

(52) U.S. Cl. 705/26; 726/30; 726/1; 726/28

(57) ABSTRACT

A method for managing a transaction in a virtual world may include generating a virtual business object (VBO), where the VBO may include a plurality of subcomponents that are each respectively related to a different aspect of the transaction associated with the virtual world object. Each subcomponent may include at least one attribute and each attribute may include information related to the subcomponent. Further, a set of enablement properties may be associated with each attribute and access to each attribute may be controlled in accordance with the set of enablement properties associated with each attribute.

### BACKGROUND

The present invention relates to simulations, virtual world simulations of the real-world or real-life or a virtual world and the like, and more particularly to a system and method for virtual business object to manage virtual world transactions.

Computer based simulations are becoming more ubiquitous. Simulations may be used for training purposes, for entertainment or for other purposes. Computer simulations such as Second Life™ or similar simulations present a virtual world which allows users or players to be represented by characters known as avatars. Second Life is a trademark of Linden Research, Inc. in the United States, other countries or both. Second Life is an Internet-based virtual world launched in 2003 by Linden Research, Inc. A downloadable client program called the Second Life Viewer enables users, called “Residents”, to interact with others in the virtual world through motional avatars. The virtual world basically simulates the real world or environment. The users or residents via their avatar can explore the virtual world, meet other users or residents, socialize, participate in individual and group activities, create and trade items (virtual property) and services from one another.

Currently, there is no known way to manage virtual world transactions or provide product information to or from a virtual business object, virtual product, or any other virtual item. For example, there is no current automated way for a manufacturer to notify customers that bought a defective product that a recall has been issued.

### BRIEF SUMMARY

In accordance with an aspect of the present invention, a method for managing a transaction in a virtual world may include generating a virtual business object (VBO). The VBO may include a plurality of subcomponents in which each subcomponent is respectively related to a different aspect of the transaction associated with the virtual world object. Also, each subcomponent may include at least one attribute and each attribute may include information related to the subcomponent. Further, a set of enablement properties may be associated with each attribute and access to each attribute may be controlled in accordance with the set of enablement properties associated with each attribute.

In accordance with another aspect of the present invention, a system for managing a transaction in a virtual world may include a processor and a module operable on the processor to generate a virtual business object (VBO), where the VBO comprises a plurality of subcomponents that is each respectively related to a different aspect of the transaction associated with the virtual world object. Each subcomponent may include at least one attribute and each attribute may include information related to the subcomponent. Further, a set of enablement properties may be associated with each attribute and access to each attribute may be controlled in accordance with the set of enablement properties associated with each attribute.

In accordance with another aspect of the present invention, a computer program product for managing a transaction in a virtual world may include a computer usable medium having computer usable program code embodied therein. The computer usable medium may include computer usable program code configured generate a virtual business object (VBO), where the VBO comprises a plurality of subcomponents that is each respectively related to a different aspect of the transaction associated with the virtual world object. Each subcomponent may include at least one attribute and each attribute may include information related to the subcomponent. The computer usable program code may be configured to associate a set of enablement properties with each attribute and to control access to each attribute in accordance with the set of enablement properties associated with each attribute.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIG. 1 is a flow chart of an example of a method for managing a transaction in a virtual world in accordance with an embodiment of the present invention.

FIG. 2 is a block schematic diagram of an example of a virtual business object of a system for managing a transaction in a virtual world in accordance with an embodiment of the present invention.

FIG. 3 is an example of a database entry of a virtual world business object generated as part of a method for managing a transaction in a virtual world in accordance with an embodiment of the present invention.

FIG. 4 is a flow chart of an example of a method for managing a purchasing and shipping aspect of the transaction in the virtual world in accordance with another embodiment of the present invention.

FIG. 5 is a flow chart of another example of a method for tracking, shipping and delivery of a virtual world object associated with the transaction in the virtual world in accordance with an embodiment of the present invention.

FIG. 6 is a flow chart of an example of a method for managing the transaction in the virtual world after delivery of the virtual world object in accordance with still yet another embodiment of the present invention.

FIG. 7 is a block schematic diagram of an example of a system for managing a transaction in a virtual world in accordance with another embodiment of the present invention.

### DETAILED DESCRIPTION

The following detailed description of embodiments refers to the accompanying drawings, which illustrate specific embodiments of the invention. Other embodiments having different structures and operations do not depart from the scope of the present invention.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a tangible medium such as a portable computer diskette, a hard disk, a random access memory (RAM), a read-only memory (ROM), an erasable programmable read-only memory (EPROM or Flash memory), an optical fiber, a portable compact disc read-only memory (CD-ROM), or other tangible optical or magnetic storage device; or transmission media such as those supporting the Internet or an intranet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages, or in functional programming languages, such as Haskell, Standard Meta Language (SML) or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

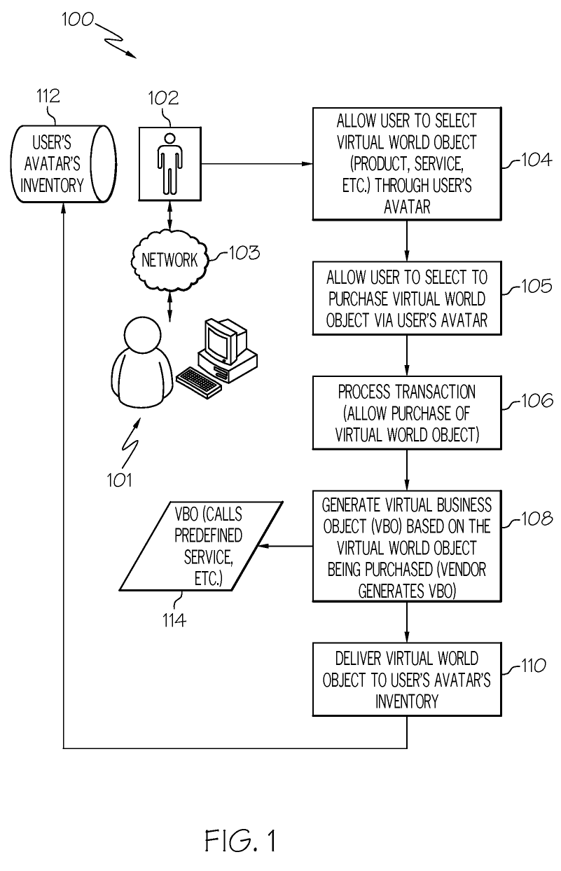

FIG. 1 is a flow chart of an example of a method for managing a transaction in a virtual world in accordance with an embodiment of the present invention. In block 104, a user 101 is allowed to select a virtual world object (not shown) through actions of the user 101 using a computer system to control the user's avatar 102 via a network 103. The virtual world object may be any product, service, or the like. The user's avatar 102 may select the virtual world object in any manner, such as tagging the virtual world object, indicating interest in the virtual world object, reserving the virtual world object, or any other way an avatar may select an object.

In block 105, the user 101 is allowed to select to purchase the virtual world object via the user's avatar 102 by any means, such as placing the virtual world object in a shopping cart, carrying the virtual world object to a checkout location, or any other method of indicating that the user's avatar 102 would like to purchase the virtual world object.

In block 106, the user's avatar 102 is allowed to complete the transaction and purchase the selected virtual world object. The transaction may be processed by transferring legal consideration, such as money, property, a future promise, and the like, for the virtual world object. By purchasing the virtual world object, possession of the virtual world object may transfer to the user's avatar 102 or to a location associated with the user's avatar 102.

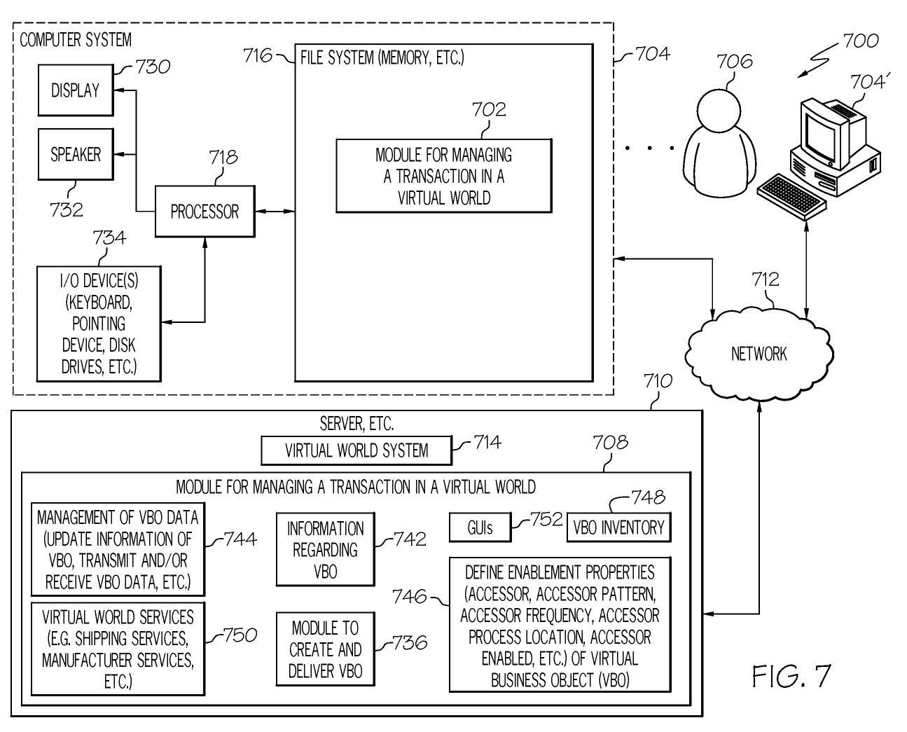

In block 108, a virtual business object (VBO) 114 may be generated based on the virtual world object being purchased. The VBO 114 is an object in the virtual world associated with a user 101 or user's avatar 102 and may virtually represent a virtual world object. In one embodiment, the virtual world object may correspond to a real world object selected by the user 101 such that the real world object is mapped onto the virtual world. For example, if a user 101 purchases a real world product, service or the like, a virtual world object corresponding to the real world object may be generated and, in this way, the real world object may be mapped onto the virtual world as the virtual world object that is associated with the user's avatar 102. The VBO 114 is generated based on information corresponding to the virtual world object. Further, the VBO 114 may be generated by any entity in the virtual world, such as a module to create the VBO on a virtual world server (as discussed later with reference to block 736 of FIG. 7), a vendor of the virtual world object, or any other means or entity in the virtual world system.

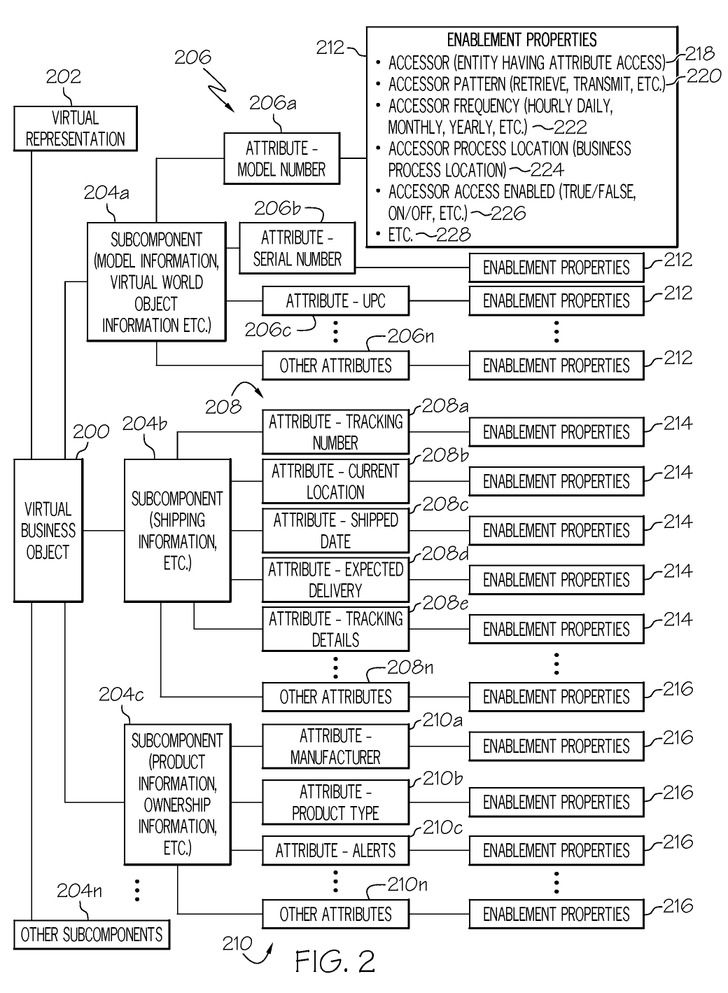

FIG. 2 is a block schematic diagram of an example of a virtual business object of a system for managing a transaction in a virtual world in accordance with an embodiment of the present invention. As shown in FIG. 2, the VBO 200 may include an object of a Virtual representation 202 of the virtual world object purchased as well as a plurality of subcomponents 204a-204n. Each subcomponent 204a-204n may be related to a different aspect of the transaction associated with the virtual world object, such as, for example, model information, shipping information, product information, product ownership information, product manuals, product warranties, and any other subcomponents related to purchasing the virtual world object.

Further, each subcomponent 204a-204n of the VBO 200 may have at least one attribute 206, 208, 210 that includes information related to the subcomponent 204a-204n. For example, a subcomponent 204a related to model information may have attributes 206a-206n associated with the model information, such as product serial number 206b, universal product code (UPC) 206c, model number 206a, or other related product attributes 206n; a subcomponent 204b related to shipping information may include attributes 208a-208n associated with shipping of the virtual world object, such as tracking number 208a, current product location 208b, shipped date 208c, expected delivery 208d, tracking details 208e or other shipping attributes 208n; and a subcomponent 204c associated with the specific virtual world object related to any warranties and alerts related to the virtual world object, where the alerts may be recalls, updates, safety issues with the virtual world object, product news and other alert related information associated with the virtual world object.

Further, each attribute 206, 208, 210 may include a set of enablement properties 212-216 that controls access to each attribute 206, 208, 210, such access may include the ability to access and/or change subcomponent attribute information or alter the transaction process. Examples of enablement properties 212-216 may include defining an accessor 218, accessor pattern 220, accessor frequency 222, accessor process location 224, accessor access enablement 226 or any other property for defining access to the attribute information 228.

The accessor 220 may be any entity, such as a company or any interested party, that may have access to retrieve and/or update attribute information 206, 208, 210 of the VBO subcomponent 204a-204n. The accessor enablement property 212-216 may be associated with only one specified subcomponent 204a-204n so as to grant, limit or deny access to the specific subcomponent 204a-204n.

The accessor pattern 220 specifies a manner in which a business process associated with the subcomponent 204a-204n is invocable, such as retrieve, transmit and the like. For example, an accessor pattern enablement property 220 may be set to “retrieve” to allow an accessor to initiate a local script to access the VBO subcomponent 204a-204n or attribute 206, 208, 210 thereof. The accessor pattern 220 may be initiated by a local script accessing the VBO subcomponent 204a-204n.

The accessor frequency 222 defines how often the business process associated with the subcomponent 204a-204n may be invoked, such as hourly, daily, monthly, yearly, or some other time frame.

The accessor access enabled 226 defines a configurable option to permit a user or a user's avatar to override any user changeable attribute 206, 208, 210 and/or to abort the business process or accessor access depending on the stage of the transaction. The accessor access enabled enablement property 226 may be set to grant, limit, or deny access by the accessor to one or more VBO subcomponents 204a-204n and/or attributes 206, 208, 210. Values of the accessor access enabled enablement property 226 may include, “true/false,” “enable/disable,” “allow/disallow,” “grant/limit/deny,” “activate/deactivate,” and the like.

The accessor process location 224 indicates the location of a provider associated with the subcomponent 204a-204n and provides the location of the business process, such as an online location, a virtual world location, and the like. A business process may be, for example: (1) a shipping information process, which may include processes to determine tracking product location, expected date delivery, date shipped, tracking number or any other shipping information; (2) a product information process, such as a process to determine product news, product updates, product alerts, product recalls product updates, safety issues with the product or any other product information; and (3) a model information process, such as a process to determine the product serial number, UPC, or other model information.

Each enablement property 212 of the set of enablement properties 212 may be associated with one or more attributes 206, 208, 210 and may be defined by a user. Access to each attribute 206, 208, 210 may be controlled in accordance with the set of enablement properties 212 associated with each attribute 206, 208, 210. Further, access to each attribute 206, 208, 210 by the user based on a current aspect of the transaction associated with the virtual world object.

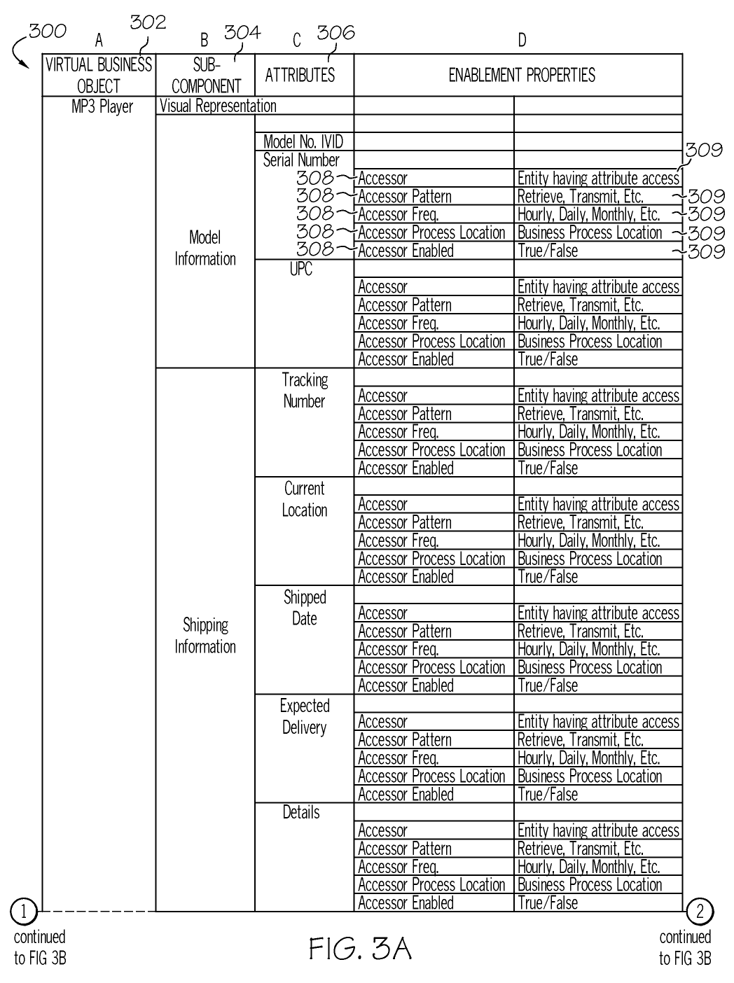

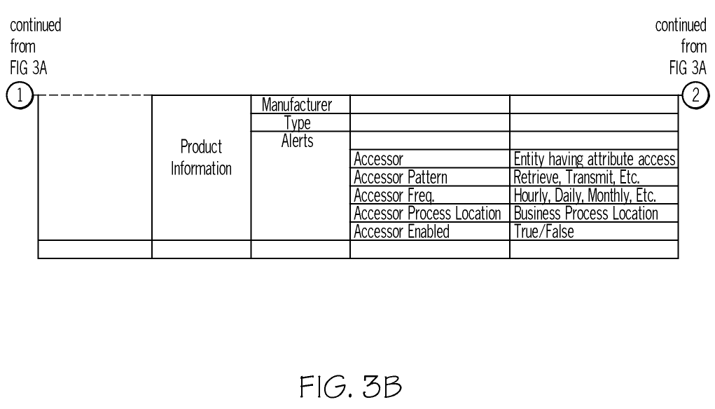

FIG. 3 is an example of a database entry of a virtual world business object generated as part of a method for managing a transaction in a virtual world in accordance with an embodiment of the present invention. Subcomponents 304, attributes 306, and/or enablement properties 308 may be stored in a database entry 300 in an arrangement associating the enablement properties 308 with the attributes 306 and corresponding the attributes 306 with the subcomponents 304 of the VBO 302. The database entry 300 may be associated with a VBO, such as a MP3 player. The VBO 302 in the database entry 300 may be listed in the column labeled “A.” Entries associated with the VBO subcomponents 304 may be listed in the column labeled “B” as a subcategory of the VBO entry 302, such as model information, shipping information, product information and other subcomponents. VBO attributes 306 may be listed in the column labeled “C” and may be grouped with associated VBO subcomponents as illustrated in FIG. 3. Examples of attributes 306 may include serial number, UPC, tracking number, current location, shipped date, expected delivery, details, manufacturer, product type, alerts, and other attributes. The column labeled “D” is a column listing VBO enablement properties 308 associated with each respective attribute 306. Examples of the enablement properties 308 in column “D” may include accessor, accessor pattern, accessor frequency, accessor process location, accessor access enablement and the like. Each VBO enablement property 308 is shown as associated with a respective VBO attribute 306. A value 309 associated with each enablement property 308 is listed in the column “D” adjacent to each enablement property 308. Any information of the VBO, including subcomponents 304, attributes 306, enablement properties 308, and enablement property values 309, may be queried, transmitted and/or distributed to and/or from the VBO database entry 300 in accordance with the enablement property values. Any information received by the VBO may be updated in the database entry 300 by adding new VBO data or editing existing VBO data for at least one VBO attribute for the subcomponent 304 related to the current aspect of the transaction.

Referring back to FIG. 1, in block 110, the VBO 114 may be delivered to the user's avatar's inventory 112. The VBO 114 in FIG. 1 may generally correspond to the VBO in FIGS. 2-3. The VBO 114 may have a virtual representation in the virtual world so that the VBO 114 may be viewed by the user's avatar 102 in the user's avatar's inventory 112.

Block 114 illustrates the generated VBO. The VBO 114 may call or activate predefined services or any other action to be performed. Various predefined services, such as a service to allow access to purchasing status, track shipping service, service for manufacturing alerts, updates and/or recalls, and other predefined services that may be associated with the VBO 114 may be called and/or activated by the VBO 114 depending on the current stage of the transaction, such as the purchase stage, shipping stage, delivery stage, and ownership stage. These predefined services are discussed in more detail with regard to block 750 of FIG. 7.

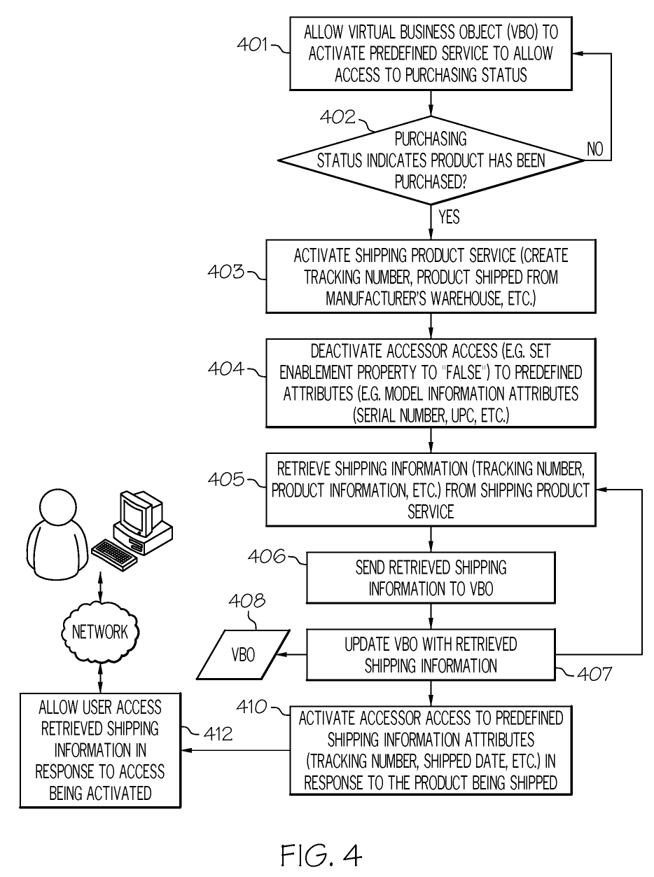

FIG. 4 is a flow chart of an example of a method for managing a purchasing and shipping aspect of the transaction in the virtual world in accordance with another embodiment of the present invention. In block 401, the VBO 408 may activate a predefined service to allow the user to access the purchasing status of the virtual world object which was selected by the user or user's avatar.

In block 402, the purchasing status of the virtual world object is determined by the purchasing status service. The purchasing status may return information indicating whether a virtual world object associated with the user or user's avatar has or has not been purchased. In response to the purchasing status service indicating that the virtual world object associated with a user's avatar has not been purchased, the purchasing status service may be restarted in block 401, and the VBO may be updated accordingly.

In block 403, in response to the purchasing status indicating that the user has purchased the virtual world object, another predefined service may be activated to ship the virtual world object from the manufacturer's warehouse and create shipping information associated the virtual world object, such as creating a tracking number, creating an invoice, or any other information associated with shipping a product.

In block 404, the user or user's avatar may set the accessor access so as not to permit access to one or more predefined attributes, such as model information attributes including product serial number, model number, UPC, and any other attribute associated with model information. For example, the accessor access may be set to not permit access by changing the accessor access enabled from “true” to “false,” “on” to “off,” “enabled” to “disabled,” “activated” to “deactivated,” and the like. When accessor access to the specific attributes are deactivated, the accessor may not be able to retrieve and/or transmit data to and/or from the associated VBO attribute.

In block 405, shipping information, such as tracking number, shipping number, and the like, may be retrieved from the shipping product service, which was activated in block 403. The retrieved shipping information may then be sent to the VBO 408 in block 406.

The VBO 408 may be updated with the received shipping information in block 407 by populating at least one attribute of the VBO subcomponent related to shipping. The VBO 408 may also be updated with any other received information, including information identifying the virtual world object, information related to shipping the virtual world object, or any other information related to the virtual world object.

In block 410, accessor access to predefined shipping information attributes may be set to permit access in response to the product being shipped. Accessor access may be set to permit access by the user or the user's avatar by allowing access via the accessor access enabled enablement property associated with the appropriate attribute. For example, a user may define the shipping company to be the accessor and also enable the accessor access enabled enablement property for each attribute associated with the VBO shipping information subcomponent so that the shipping company may then have access to the shipping information contained in the attributes associated with the VBO shipping information subcomponent. Other enablement properties associated with any of the VBO attributes may be also edited and/or added so as to properly control access to and from the VBO attributes and subcomponents.

In block 412, the user is allowed access to the retrieved shipping information in response to accessor access being set to permit access. The VBO attributes related to shipping may be continually updated so that the user may be allowed to view the most updated shipping status of the virtual world product via the VBO 408. This may continue until delivery of the virtual world product is accepted by the user and the accessor access is deactivated.

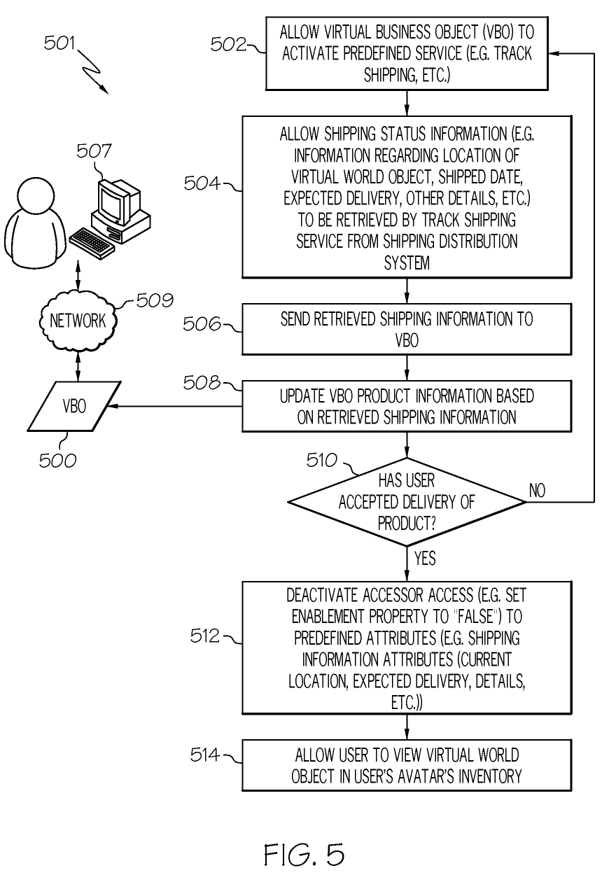

FIG. 5 is a flow chart of another example of a method for tracking, shipping and delivery of a virtual world object associated with the transaction in the virtual world in accordance with an embodiment of the present invention. In block 502, the VBO 500 may activate a predefined service to track shipping. The track shipping service may retrieve shipping status information, such as information regarding the location of the virtual world object, shipped date, expected delivery date, or other shipping details, as shown in block 504. The shipping status information may be retrieved from and/or transmitted to any source, including a shipping distribution system, a database from the shipping entity, or the like.

In block 506, the received shipping information is sent to the VBO 500. Then, the VBO 500 may be updated with the received shipping information, as shown in block 508. The user can view the updated VBO 500 on a computer 507 via a network 509.

In block 510, a determination is made whether a user has or has not accepted delivery of the virtual world object. If block 510 determines that the user has not yet accepted delivery, the method 501 may return to block 502 and re-activate the track shipping service.

In block 512, in response to the user accepting delivery of the virtual world object accessor access to predefined attributes, such as current shipping location, expected delivery date, shipping details and other shipping attributes, may be set to deny access. Accessor access may be set to deny access by setting the appropriate accessor access enabled enablement properties associated with VBO shipping information attributes to “false,” “disabled,” “deactivated,” or the like.

In block 514, the user has accepted delivery of the virtual world object and the user is allowed to view the virtual world object in the user's avatar's inventory. Accordingly, the VBO attributes related to the VBO shipping subcomponent may be updated to reflect that the virtual world object has been delivered to the user's avatar and delivery has been accepted.

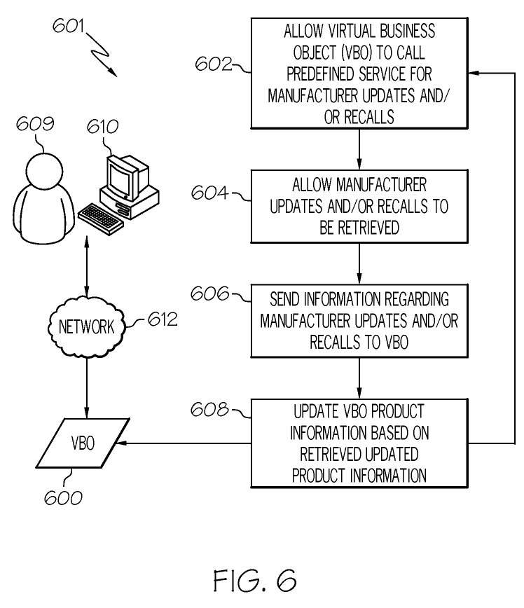

FIG. 6 is a flow chart of an example of a method for managing the transaction in the virtual world after delivery of the virtual world object in accordance with still yet another embodiment of the present invention. The VBO 600 may call a predefined service for manufacturer updates and/or recalls, shown in block 602. The predefined service for manufacturer updates and/or recalls may include any alerts regarding the virtual world object and information may be sent to or from the VBO 600, such as recalls, updates, safety issues with the virtual world object, product news and other alert related information associated with the virtual world object. For example, in the case of a defect in a manufacturer's product or an upgrade to a manufacturer's product becomes available, the manufacturer may transmit the recall and/or update information to the VBO 600 in order to notify the user and/or the user's avatar that have previously purchased or been associated with the manufacturer's product. The manufacturer alerts, updates and/or recalls may be stored in a location that is accessible by the VBO 600.

In block 604, manufacturer alerts, updates and/or recalls may be retrieved by any means, such as by a query to the manufacturer's location, obtaining updates and/or recalls transmitted by the manufacturer, and the like.

The retrieved manufacturer alert, update and/or recall information may be sent to the VBO 600, as shown in block 606. If no alert, update and/or recall information is received, no information may be transmitted to the VBO 600 or a message may be sent to the VBO 600 indicating that no alerts, recalls and/or updates exist.

In block 608, the VBO 600 is updated based on retrieved manufacturer alerts, updates and/or recalls. Specifically, manufacturer information may be inserted into the VBO attributes related to the VBO product information subcomponent. The updated VBO 600 may be viewed by the user 609 via a computer 610 on a network 612 connected to the VBO 600.

FIG. 7 is a block schematic diagram of an example of a system for managing a transaction in a virtual world in accordance with another embodiment of the present invention. The system 700 may include a module for managing a transaction in a virtual world (hereinafter “VBO module”) 702 operable on a computer system 704, or similar device of a user 706 or client. Alternatively, or in addition to the VBO module 702 on the user's computer system 704 or client, the system 700 may include a VBO module 708 operable on a server 710 (hereinafter “server VBO module”) and accessible by the user 706 or client 704 via a network 712. The methods 100, 400, 500, and 600 [not sure what 100, 400, 500, 600 refer to? Are they FIGS. 1, 4, 5, and 6? I don't have anything labeled 400 in FIGS. 4 and 500 in FIG. 5 is a VBO. am I reading incorrectly?] may be embodied in or performed by the VBO module 702 and/or the server VBO module 708. For example, the methods 100, 400, 500, and 600 may be performed by the VBO module 702. In another embodiment of the invention, the methods 100, 400, 500, and 600 may be performed by the server VBO module 708. In a further embodiment of the present invention, some of the features or functions of the methods 100, 400, 500, and 600 may be performed by the VBO module 702 on the user's computer system 704 and other features or functions of the methods 100, 400, 500, and 600 may be performed on the server VBO module 708.

A virtual world simulation system 714 may be operable on the server 710 and may be accessible by a plurality of users 706 or participants using an Internet browser on their respective computer systems 704 or clients. The virtual world simulation system 714 may also be operable on another server separate from the server 710 on which the VBO module 708 is operable. The virtual world simulation 714 may be Second Life™ or a similar virtual world system. The VBO modules 702 and 708 may be part of the virtual world simulation system 714 or may be separate applications or modules that interface with the virtual world simulation 714. The network 712 may be the Internet, a private network or other network. Each computer system 704′ may be similar to the exemplary computer system 704 and associated components illustrated in FIG. 7.

The VBO module 702 and/or 708 may be a self contained system with embedded logic, decision making, state based operations and other functions that may operate in conjunction with a virtual world simulation, such as Second Life™. The self contained system may allow businesses, individuals, services, locations, and the like in the virtual world to interact.

The VBO module 702 may be stored on a file system 716 or memory of the computer system 704. The VBO module 702 may be accessed from the file system 716 and run on a processor 718 associated with the computer system 704.

The user computer system 704 may also include a display 730 and a speaker 732 or speaker system. The display 730 may present the virtual world and the user's avatar as described herein and may permit control of the user's avatar. Any GUIs 752 associated with the VBO module 708 and VBO may also be presented on the display 730. The speaker 732 may present any voice or other auditory signals or information to the user 706.

The user computer system 704 may also include one or more input devices, output devices or combination input and output device, collectively I/O devices 734. The I/O devices 734 may include a keyboard, computer pointing device or similar means to control operation of avatars and the VBO creation and management described herein. The I/O devices 734 may also include disk drives or devices for reading computer media including computer-readable or computer-operable instructions.

The server VBO module 708 may include a module to create and deliver the VBO 736 (hereinafter “VBO creation and delivery module”). The VBO creation and delivery module 736 may perform various tasks with respect to creating and configuring the VBO, including VBO generation or creation, determining the VBO subcomponents, attributes and enablement properties based on the virtual world object, determining the VBO configurations, associating one or more enablement property values with the VBO attributes, and any other functions that may be appropriate for creating a VBO and/or managing a virtual world transaction. As previously discussed with respect to block 108 of FIG. 1, to create a VBO, the newly created VBO associated with a user or user's avatar may be based on a virtual world object purchased by the user or user's avatar. The VBO creation and delivery module 736 may generate the VBO immediately upon the user or user's avatar purchasing a virtual world object. Although the VBO creation and delivery module 736 has heretofore been used to generate a new VBO when the user or user's avatar purchases a virtual world object, the VBO creation and delivery module 736 may generate a VBO upon the triggering of any predetermined stimulus. Regardless, when a VBO is created, the VBO creation and delivery module 736 may also deliver or store the VBO to the VBO inventory 748 associated with the user or the user's avatar, as is discussed below with respect to block 748.

The server VBO module 708 may also include information regarding the VBO 742. VBO information 742 may include any subcomponents, attributes, enablement properties, enablement property values, data transmitted to or from the VBO, and any other information or settings associated with the VBO. Examples of VBO information 742 may include product information, model information, shipping information, VBO alerts, updates and/or recalls, and the like. The VBO creation and delivery module 736 may create and store VBO information 742 on the server VBO module 708 when the VBO is initially created. The VBO information 742 may be accessed by other modules in the server VBO module 708 or may be accessed by a user or user's avatar via the VBO module 702.

The server VBO module 708 may also include a module for management of VBO data 744. The module for management of VBO data 744 may perform various tasks with respect to the maintenance of VBO data, including managing how, when and what VBO data will be transferred to and from the VBO, updating information of the VBO, transmitting and/or receiving VBO data, retrieving VBO information, and other functions which may be appropriate for managing VBO data. The module for management of VBO data 744 may access VBO information 742 to retrieve and/or transmit VBO data thereto and/or therefrom. Further, the module for management of VBO data 744 may also access other modules in managing the VBO data.

The server VBO module 708 may further include a module to define enablement properties 746. The module to define enablement properties 746 may allow a user, computer system or other entity to input various enablement properties for a range of VBO subcomponent attributes into the computer system 704. The module for defining enablement properties 746 may be accessed or activated whenever the user desires to input information and may call other modules such as the management of VBO data module 744 or GUIs 752 as described below. The module for defining enablement properties 746 also allows input of the enablement properties by any virtual world entity based on various transaction stages, by any software communicative with the virtual world system that may analyze the transactions of the user's avatar and/or by any other entity that may determine that the enablement properties may be entered and/or need to be changed. The module for defining enablement properties 746 allows a user, user's avatar or some other entity (e.g. manufacturer, retailer, shipper, etc.) to activate and deactivate access to at least one attribute based on a current aspect of the transaction associated with the VBO. For example, in the case of a virtual world object being shipped, a user may allow access for a shipping company to shipping information by defining the shipping company as an accessor and setting the enablement property associated with accessor access to an activation value, such as “true,” “enable,” “activate,” and the like. Also, once the virtual world product has been shipped, the user or user's avatar may deactivate the shipping company's access to shipping information by setting the enablement property associated with accessor access to a deactivation value, such as “false,” “deactivate,” disable,” and the like. In one embodiment, the control of enablement properties is transferred to another entity, such as the manufacturer, shipper, etc. depending on the stage of the transaction.

The server VBO module 708 may also include a VBO inventory 748. The VBO inventory 748 may include one or more VBOs. As previously described with respect to block 108 of FIG. 1, a VBO is an object in the virtual world associated with a user or user's avatar and may virtually represent a virtual world object or a real world object. Further, as previously described with respect to FIGS. 2 and 3, each VBO may include a virtual representation as well as subcomponents, attributes and enablement properties. The VBO may be generated after a virtual world object is purchased. After generating or creating the VBO, the VBO is delivered to the VBO inventory 748 associated with the user or the user's avatar. The VBO inventory 748 may be stored locally on the user's computer 704 or the user's computer readable storage medium in a database (not shown). The VBO inventory 748 may also be stored remotely on the network 712 in the database. The VBO inventory 748 may be accessed, queried and/or distributed at any time remotely by the server 710 or locally by the computer system 704.

The server VBO module 708 may additionally include virtual world services 750. The virtual world services 750 may be any existing or possible services or actions that may be performed by any entity in the virtual world, such as shipping services, manufacturer services, service for checking the purchasing status of a virtual world object, service to track shipping, or any other possible virtual world services. The virtual world services 750 may be called, activated, and/or queued at any time remotely by the VBO, management of VBO data module 744, or other modules either remotely on the server 710 or locally on the computer system 704. For example, predefined virtual world services are called by the VBO in blocks 401 and 403 of FIG. 4, block 502 of FIG. 5, and block 602 of FIG. 6. The virtual world services 750 may be queried or may transmit information to and from various modules in the VBO module 708.

The server VBO module 708 may further include GUIs 752. The server VBO module 708 may present one or more predetermined GUIs 752 to permit the user to define VBO enablement properties associated with a user's avatar's or any other information and/or settings. The GUIs 752 may be predetermined and/or presented in response to the user indicating the user would like to enter information and/or settings. The predetermined GUIs may be generated by the server VBO module 708 and may be presented on the display 730 of the computer system 704. The GUIs 752 may also include GUIs that permit a virtual world system operator or owner to manage operations associated with the VBO, such as managing and/or controlling VBO data and information, creating and delivering a VBO, managing VBO inventory, managing virtual world services, as well as any other functions or features associated with the VBO.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for managing a transaction in a virtual world, comprising:
generating a virtual business object (VBO), wherein the VBO comprises a plurality of subcomponents each respectively related to a different aspect of the transaction associated with the virtual world object and each subcomponent comprising at least one attribute, wherein each attribute comprises information related to the subcomponent;
associating a set of enablement properties with each attribute; and
controlling access to each attribute in accordance with the set of enablement properties associated with each attribute.

2. The method of claim 1, further comprising allowing a user to define each enablement property of the set of enablement properties.

3. The method of claim 1, further comprising allowing the VBO to activate a predefined service based on a current stage of the transaction, wherein the current stage of the transaction comprises at least one of a purchase stage, a shipping stage, a delivery stage, and an ownership stage.

4. The method of claim 1, further comprising:
activating access for a user to access the at least one attribute based on a current aspect of the transaction associated with the virtual world object; and
deactivating access to the at least one attribute in response to another aspect of the transaction being entered.

5. The method of claim 1, wherein associating the set of enablement properties with each attribute comprises associating at least one of: an accessor, an accessor pattern, an accessor frequency, an accessor location, and an accessor access enablement property with each attribute, wherein the accessor defines who has access to update the attribute; the accessor pattern specifies a manner in which a process associated with the subcomponent is invocable; the accessor frequency defines how often the process associated with the subcomponent is invocable; the accessor process location indicates a location of a provider associated with the subcomponent; and the accessor access enablement property defines a configurable feature to permit one of the user and the user's avatar to override any user changeable attribute and to abort the process depending on a stage of the transaction.

6. The method of claim 1, wherein associating the set of enablement properties with each attribute comprises associating a configurable feature to permit one of the user and the user's avatar to override any user changeable attributes and to terminate the transaction depending upon a current subcomponent.

7. The method of claim 1, wherein generating the VBO comprises:
generating a subcomponent for information associated with a specific virtual world object selected for purchase;
generating a subcomponent for shipping information associated with the specific virtual world object selected for purchase; and
generating a subcomponent for information associated with the specific virtual world object related to any warranties and alerts related to the virtual world object.

8. The method of claim 1, further comprising delivering the virtual world object to a virtual world object inventory associated with the user's avatar.

9. The method of claim 1, further comprising one of:
activating a predefined service based on a current aspect of the transaction;
retrieving information associated with the predefined service; and
updating the VBO based on the retrieved information.

10. The method of claim 9, further comprising allowing the user to access the updated VBO in response to an access enablement property being set to allow access.

11. The method of claim 9, wherein updating the VBO comprises inserting information for the at least one attribute for the subcomponent related to the current aspect of the transaction.

12. The method of claim 1, further comprising:
updating the VBO to include information identifying the virtual world object in response to the user's avatar selecting the virtual world object for purchase;
allowing the user to select a different virtual world object if an access enablement property of the set of enablement properties is set to allow access to the at least one attribute for the subcomponent; and
setting the access enablement property to not allow access in response to the virtual world object being purchased and shipped to the user's avatar.

13. The method of claim 1, further comprising:
activating a predefined service to allow a purchasing status of the virtual world object to be accessed by the user; and
activating another predefined service to retrieve shipping information for updating the VBO in response to the purchasing status indicating the user's avatar selected to purchase the virtual world object.

14. The method of claim 1, further comprising:
activating a track shipping service in response to the virtual world object being shipped to the user's avatar in the virtual world;
retrieving shipping information associated with the track shipping service;
updating the VBO based on the retrieved shipping information; and
allowing the user to access the retrieved shipping information in response to an access enablement property associated with the retrieved shipping information being set to allow access.

15. The method of claim 14, further comprising:
determining if the user's avatar has accepted delivery of the virtual world object;
deactivating access to the shipping information in response to the user's avatar accepting delivery of the virtual world object; and
allowing the user to view the virtual world object in the user's avatar's virtual world object inventory.

16. The method of claim 1, further comprising one of:
allowing an accessor to access VBO information in response to an accessor access enablement property being set to permit access; and
denying the accessor to access VBO information in response to the accessor access enablement property being set to not permit access.

17. The method of claim 1, further comprising:
allowing the VBO to activate a service for any alerts;
updating the VBO with any alert information; and
allowing the user access to view the alert information.

18. The method of claim 1, further comprising:
updating the VBO by populating the at least one attribute of a first subcomponent with information identifying the virtual world object selected by the user's avatar for purchase;
updating the VBO by populating the at least one attribute of a second subcomponent with information related to shipping the virtual world object to the user's avatar in the virtual world; and
updating the VBO by populating the at least one attribute of a third subcomponent with information related to any alerts related to the virtual world object.

19. A system for managing a transaction in a virtual world, comprising:
a processor; and
a module operable on the processor to
generate a virtual business object (VBO), wherein the VBO comprises a plurality of subcomponents each respectively related to a different aspect of the transaction associated with the virtual world object and each subcomponent comprising at least one attribute, wherein each attribute comprises information related to the subcomponent;
associate a set of enablement properties with each attribute; and
control access to each attribute in accordance with the set of enablement properties associated with each attribute.

20. A computer program product for managing a transaction in a virtual world, comprising
a computer usable medium having computer usable program code embodied therein, the computer usable medium comprising:
computer usable program code configured to generate a virtual business object (VBO), wherein the VBO comprises a plurality of subcomponents each respectively related to a different aspect of the transaction associated with the virtual world object and each subcomponent comprising at least one attribute, wherein each attribute comprises information related to the subcomponent;
computer usable program code configured to associate a set of enablement properties with each attribute; and
computer usable program code configured to control access to each attribute in accordance with the set of enablement properties associated with each attribute.
